(19) United States
(12) Patent Application Publication
(10) Pub. No.: US 2002/0057207 A1
(43) Pub. Date: May 16, 2002

(54) CONTROL INTERFACE FOR AUDIO VIDEO COMPONENTS

(76) Inventors: WILLIAM J. SGAMBATI, CHESTNUT RIDGE, NY (US); JEFFREY W. ROBERTS, MONSEY, NY (US)

Correspondence Address: JERRY A MILLER, SONY CORPORATION OF AMERICA, 1 SONY DRIVE MD T1 1, PARK RIDGE, NJ, 07656

(21) Appl. No.: 09/065,834

(22) Filed: Apr. 24, 1998

(51) Int. Cl. H04Q 1/00

(52) U.S. Cl. 340/825.25; 340/825.72; 345/173

(57) ABSTRACT

An electronic component system having a control device capable of generating command signals, and receiving communication signals, in accordance with a first signal protocol. At least one electronic component is provided that is capable of receiving command signals, and generating communication signals, in accordance with a second signal protocol. A communications interface is coupled between the control device and the at least one component, and is adapted and constructed to receive command signals from the control device, translate the command signals from the first signal protocol to the second signal protocol, and transmit the translated command signals to the at least one component. The communications interface may also be adapted and constructed to receive communication signals from the at least one component, translate the communication signals from the second signal protocol to the first signal protocol, and transmit the translated communication signals to the control device.

### FIELD OF THE INVENTION

This invention relates generally to control connections for audio and video components in electronic component systems. In particular, the preferred embodiment of the invention relates to a communications interface between a control device and audio and video components.

### BACKGROUND

In recent memory, the quality and sophistication of home entertainment systems have risen astronomically. Specifications and features which were found only on the most advanced and expensive systems just a few years ago are now considered basic requirements, and are expected by consumers as standard equipment. The quality and sophistication of control systems for such components have experienced a similar remarkable development, and consumer expectations have risen correspondingly in this area as well.

For example, in bygone days, a stereophile was required to press the actuation button of a cassette deck with one hand while dropping the tone arm of a turntable with the other, hoping against hope that the recordable area of tape would coincide precisely with the first few notes from the vinyl platter. Such acts of contortion were supplanted by remote control juggling acts, in which the AV operator had to select from a plurality of remote control units, flipping from hand to hand to program each component. This was in turn replaced by so-called “universal” remote controls, which require the user to program commands for each component into a comprehensive but often complicated hand-held unit.

Today, the expectation is that a single stroke of a remote control unit or touch of a screen will cause (for example) the satellite system, VCR, and surround sound audio to coact in perfect synchronicity, perhaps even while the system's owner is no longer present. This expectation is met with integrated audio-video systems, some using touch screen or PC technology to achieve virtually seamless component control.

Such control systems have been the subject of some degree of inventive activity. One such system is described in U.S Pat. No. 5,548,725 to Tanaka et al., which is directed to a method and apparatus for transmitting a command and/or data between audio/video appliances. A control system for audio data is set forth in U.S. Pat. No. 5,487,067 to Matsushige. This system allows a “master” device to communicate with and control a plurality of “slave” devices.

Unfortunately, despite their convenience and effectiveness, some such home entertainment control systems have drawbacks of their own. For example, such systems often require non-standard communications protocols to enhance the ability of the system to provide component status data to the central controller. This can limit the ability of consumers to “mix and match” components and controllers from different manufacturers, or to integrate new components into existing systems, and still retain the advantages of their control systems.

It can be seen from the foregoing that the need exists for a control system for audio-video components that will enable communication between a control device and system components even though the control device and components use different communications protocols.

### SUMMARY

One embodiment of the present invention achieves these and other objects by providing an electronic component system having a control device capable of generating command signals, and receiving communication signals, in accordance with a first signal protocol. At least one electronic component is provided that is capable of receiving command signals, and generating communication signals, in accordance with a second signal protocol. A communications interface is connected between the control device and the at least one component, and is adapted and constructed to receive command signals from the control device, translate the command signals from the first signal protocol to the second signal protocol, and transmit the translated command signals to the at least one component. The communications interface may also be adapted and constructed to receive communication signals from the at least one component, translate the communication signals from the second signal protocol to the first signal protocol, and transmit the translated communication signals to the control device. The first signal protocol can be an RS 232 command protocol. The communications interface can include a microcontroller adapted and constructed to receive and process command signals from the control device, and can also be provided with a memory device storing a look-up table connected to the microcontroller.

The memory device may be provided, for example, as ROM, RAM, optical storage, or magnetic storage. The communications interface may include an output circuit adapted to transmit data signals from the control device to the at least one component and to transmit status signals from the at least one component to the control device. The control device itself may include an input device, such as an infrared or RF remote control unit, and may also include a display device. Alternatively, the input device and the display device may be integrated, as in a touch screen.

A method of effecting communication between the control device and the at least one audio-visual component according to an aspect of the invention is also disclosed. The method is described in the context of an electronic component system including a control device capable of communication using a first signal protocol and at least one device capable of communication using a second signal protocol. The method includes the step of actuating the control device to transmit communication signals. The signals generated from the control device are translated from the first signal protocol to the second signal protocol. The translated communication signals are transmitted to the at least one audio-visual component.

In another aspect of the present invention, a method sets forth the steps for communication from at least one audio-visual component to a control device. Again, this method is described in the context of an electronic component system including a control device capable of communication using a first signal protocol and at least one device capable of communication using a second signal protocol. The method includes the step of actuating the audio-visual component to transmit communication signals. The signals generated from the at least one component are translated from the second signal protocol to the first signal protocol. The translated communication signals are transmitted to the control device.

The features of the invention believed to be patentable are set forth with particularity in the appended claims. The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 is a block diagram of an electronic component system.

FIG. 2 schematically illustrates a communication interface within an electronic component system.

FIG. 3, which is divided into FIG. 3A and 3B, illustrates an electrical schematic diagram of a particular communication interface.

FIG. 4 is a flow chart of the operation of the present invention.

FIG. 5-8 are display screens for controlling electronic components using a graphical interface according to an embodiment of the present invention.

### DETAILED DESCRIPTION OF THE INVENTION

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

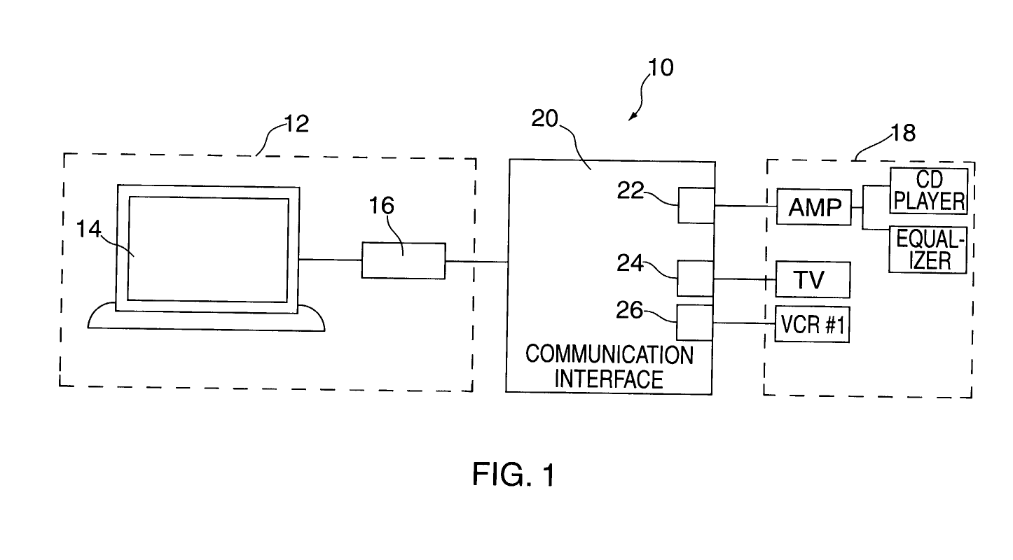

Turning now to FIG. 1, an electronic component system 10 includes a control device 12. The control device 12 can include input and display devices, here integrated as a touch screen 14, the particulars of which are known in the art. The control device 12 also includes a control command communication driver 16, here shown as a standard RS-232 switching device. The system 10 includes a plurality of audio-video electronic components 18, which may include video equipment (e.g. video tape players and recorders, television receivers, video monitors, laser disc players, DVD (Digital Versatile Disc or Digital Video Disc) units, and satellite systems) and audio equipment (e.g. receivers, amplifiers, tape decks, CD (Compact Disc) players, DAT(Digital Audio Tape) units, MD (Mini Disc) units, and surround sound systems). A control communication interface 20 connects the control device 12 to the components 18. The communication interface 20 can be provided with a variety of input/output connections. For example, I/O connection 22 may be provided as a network connection for audio components (such as amplifier, CD player and equalizer, for example) using a so-called control-A1 signal protocol. I/O connections 24 and 26 may be provided as binary connections for video components (such as TV and VCR, for example), allowing data signals to flow to, and status signals to flow from, the components. One example of such a connection is the Sony S-control interface, or “S-Link”. Still other embodiments for the I/O connections, such as IEEE 1394, will occur to those skilled in the art.

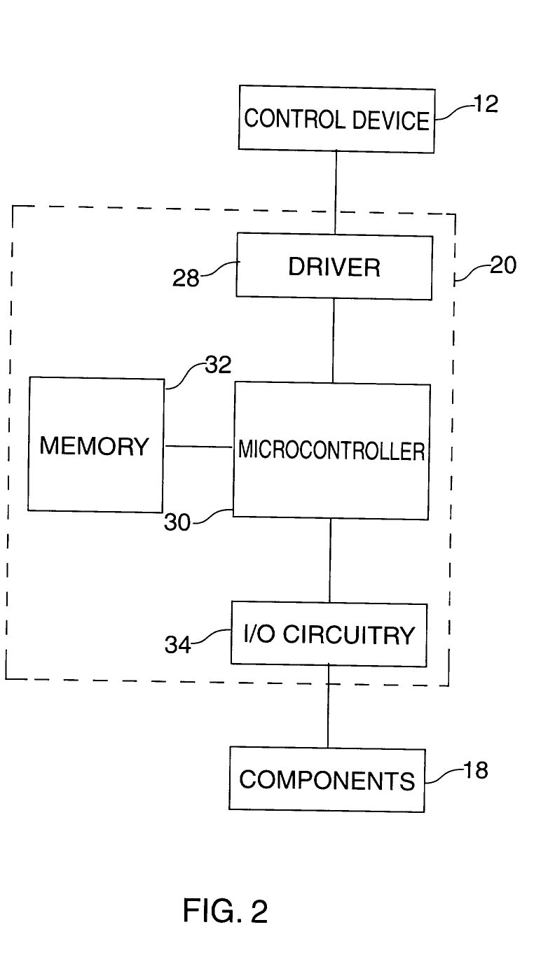

Referring to FIG. 2, a flow diagram of the operation of the control interface 20 is generally described. A control signal, for example a command signal, is generated by the control device 12 using a first signal protocol, for example, an RS-232 or IEEE 1394 command protocol. The command signal is transmitted to the control interface 20, where it is received by a signal driver/receiver 28. The driver/receiver 28 may be of any suitable type, for example, in the illustrated example of an RS 232 command protocol, the driver/receiver 28 can be provided as a commercially available MAXIM MAX232A RS-232 serial driver/receiver. From the driver/receiver 28, the command signal is transmitted to a microcontroller 30. The microcontroller 30 executes program instructions, based on the configuration of the command signal, to retrieve data stored in a memory device 32.

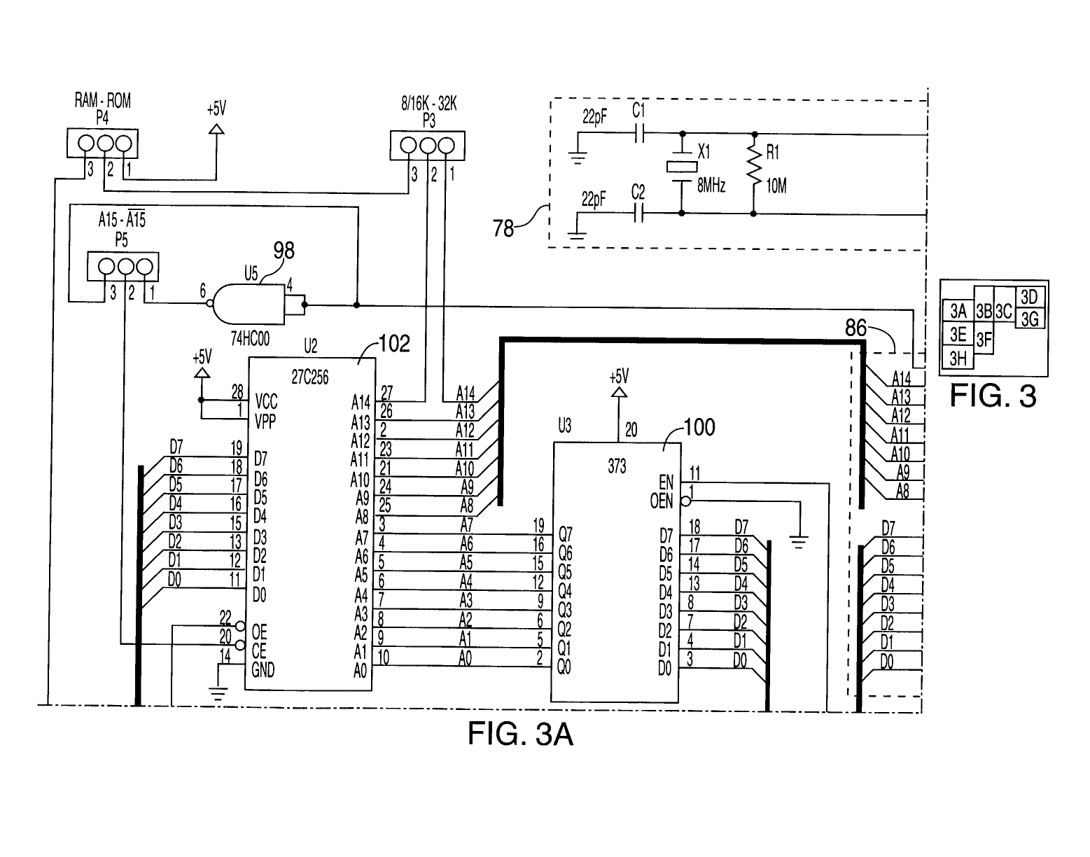

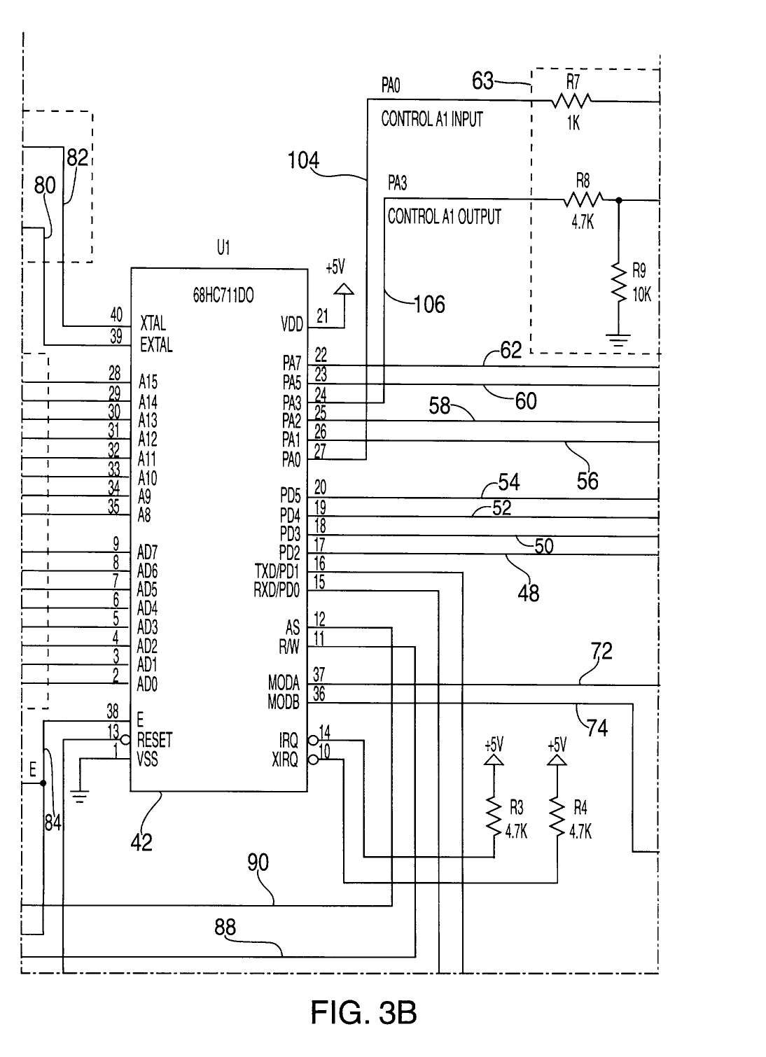

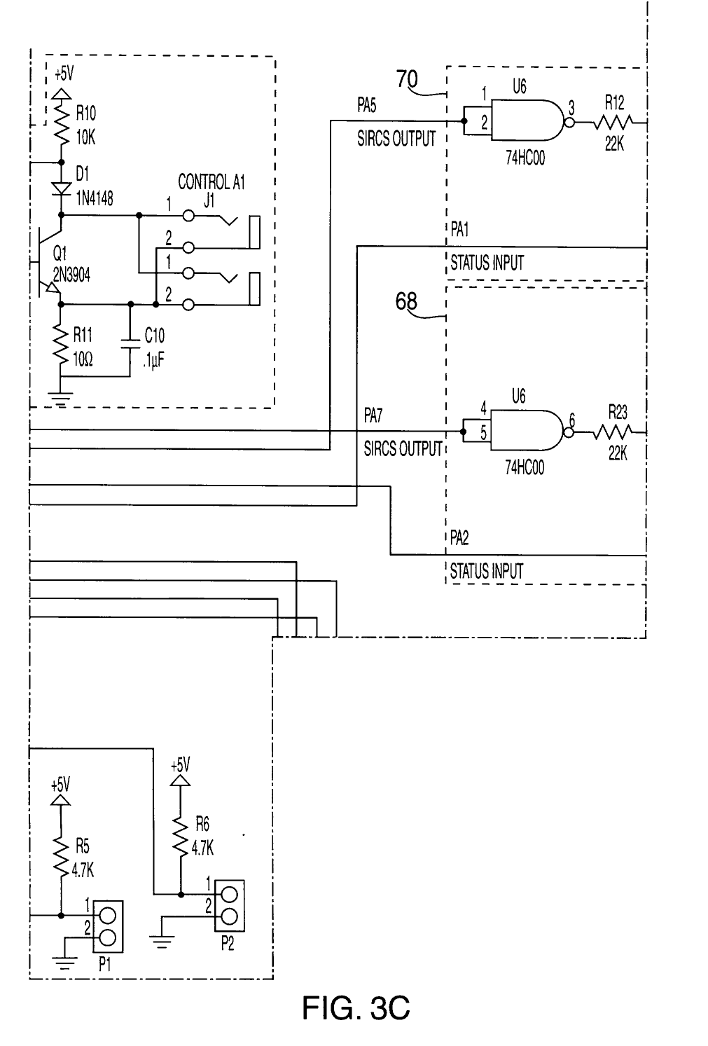

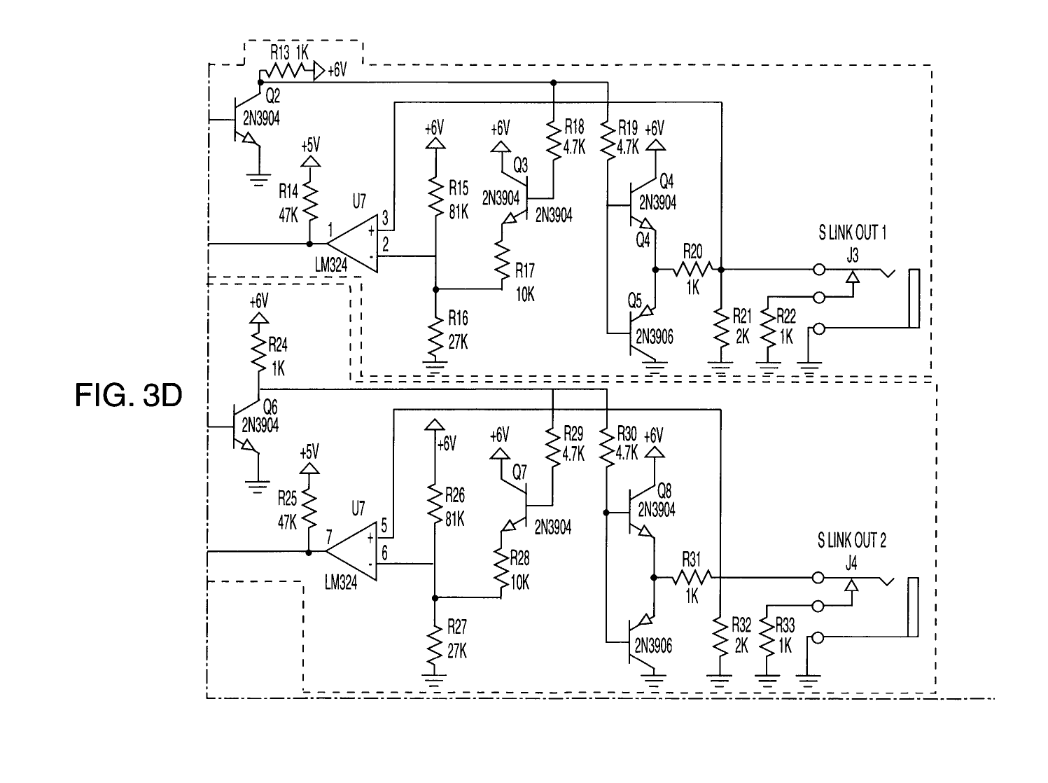

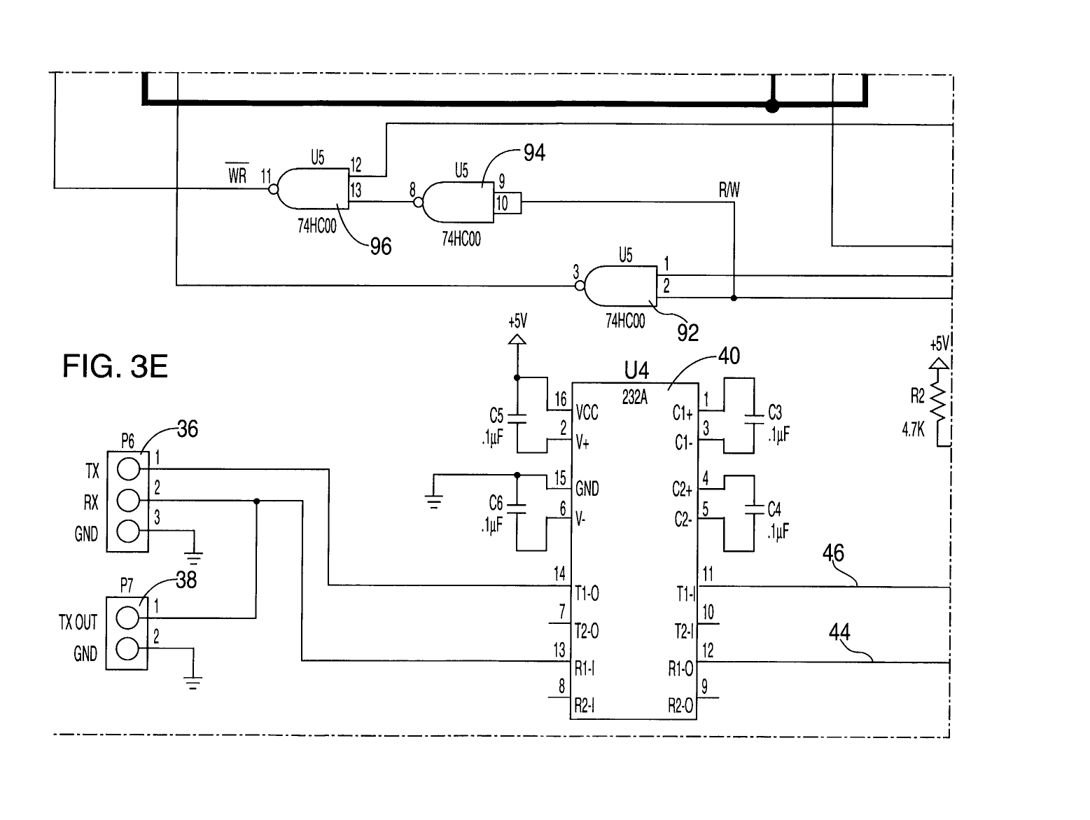

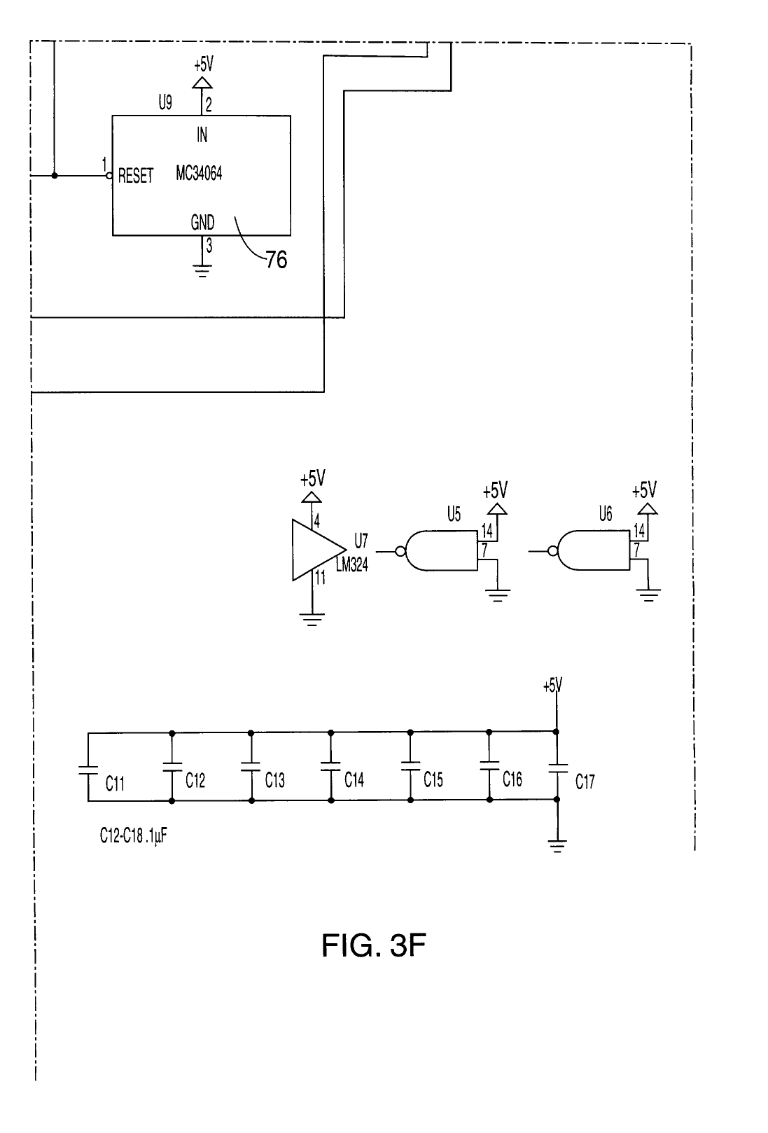

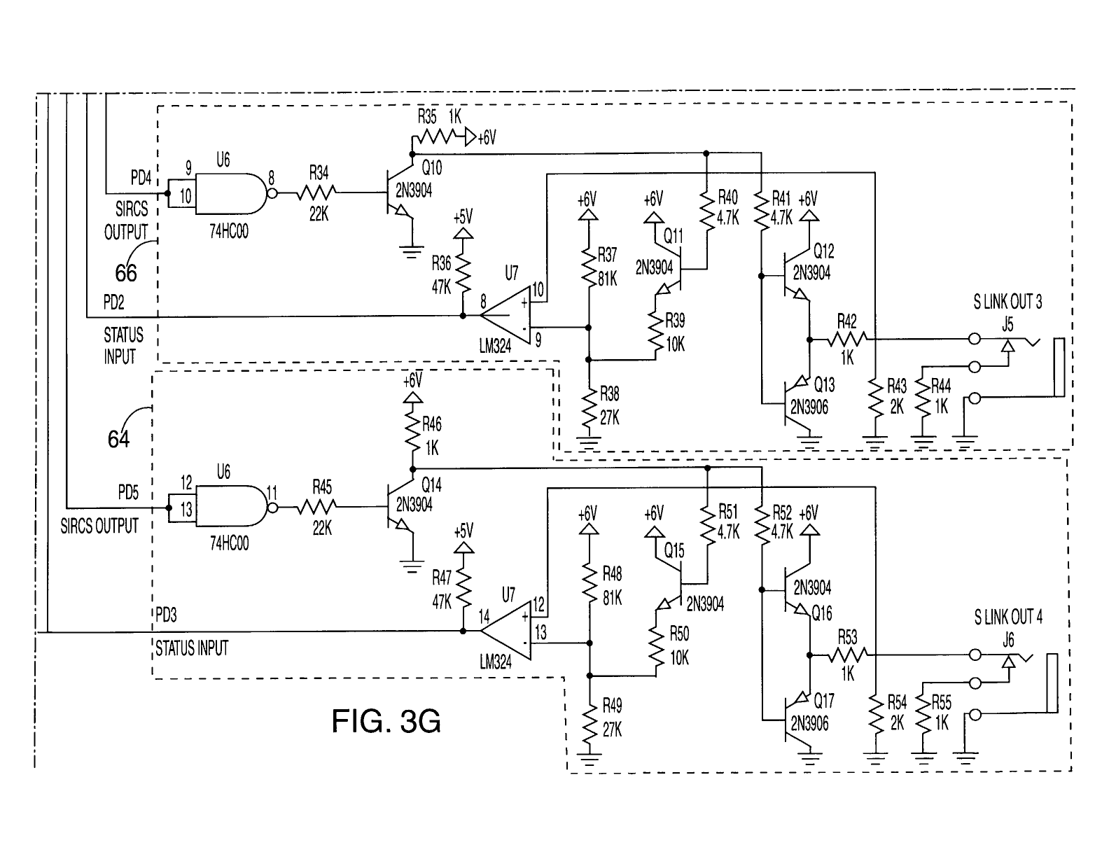

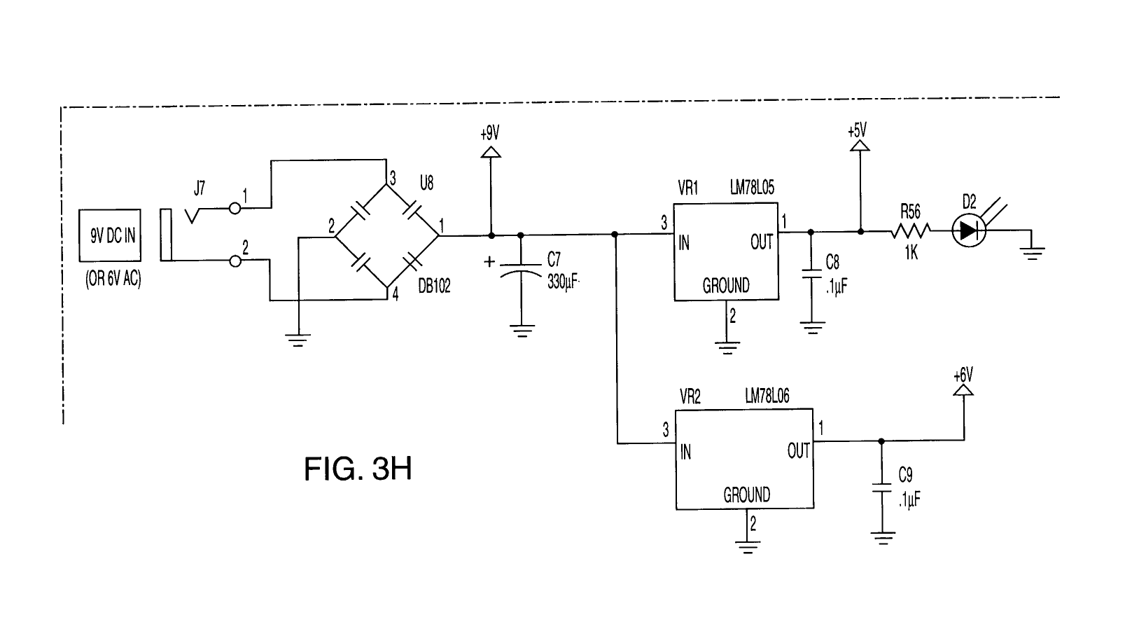

The memory device 32 uses a command set to recognize the appropriate code for the desired command. Using a look-up table, the memory device 32 determines the second communications protocol command (Control-S or Control A-1 in the illustrated example) corresponding to the command signal, thus “translating” the command from the first signal protocol to the second signal protocol. The translated command signal is then transmitted to an appropriate input/output circuit 34 via the microcontroller 30. The input/output circuit 34 buffers the voltage of the command and transmits the resulting data signal to the component 18. Memory 32 contains a look-up table containing information corresponding to control pulse sequences. The content of memory 32 is provided for the embodiment shown in FIG. 3 in the microfiche appendix included herewith and incorporated by reference. The listing shown ind this microfiche appendix is provided in ASCII text Motorola S-format The pulse sequence data are component specific commands for instructing each of the connected components 18 to perform functions. For example, one pulse sequence instructs the television to turn on, while another sequence instructs the VCR to “play”.

Based on the executed program instructions, the microcontroller 30 sends commands to the I/O circuitry 34, which in turn sends pulse sequences to the components 18 along discrete bidirectional connections. The components 18 are configured based on these instructions.

For example, commands can be sent to command the components 18 to play a videotape in the VCR #1 using the amplifier and surround processor to create a surround sound effect.

Signal flow from the component 18 to the control device 12 is essentially the reverse of that described with reference to command signals. A status signal, in this example a binary signal indicative of a variable characteristic, is generated at the component 18. This signal is in accordance with the first signal protocol, and flows through a comparator in the input/output circuit 34, from whence it is transmitted to the microcontroller 30. The microcontroller 30 executes program instructions, based on the configuration of the component status signal, to retrieve data stored in the memory device 32.

The memory device 32 uses a look-up table to locate the second communications protocol command corresponding to the received status signal, thus “translating” the command to the first signal protocol from the second signal protocol. The translated command signal is then transmitted to the control device 12 via the microcontroller 30 and the driver/receiver 28.

Referring now to FIG. 3 (made up of FIG. 3A and 3B), a detailed circuit diagram of an embodiment of the control interface 20 of the present invention is shown in detail. The specific component values and exact circuit configuration shown are specific to the current embodiment. Many variations will occur to those skilled in the art. In this embodiment, electrical terminals 36, 38 are connected to a suitable command control communication driver, such as a MAXIM MAX232A RS-232 Driver/Receiver shown at 40 in FIG. 3A. The command control communication driver 40 is connected to a suitable microcontroller 42, such as a commercially available Motorola MC68HC11 D0 8-bit microcontroller unit, to form a serial communications interface (SCI). Other suitable microprocessors or general purpose processors may be used. A serial shift register of the microcontroller 42 receives data via RX data line 44, while an output of the serial shift register of the microcontroller 42 is transmitted to the control communication driver 40 via TX data line 46.

I/O data lines, such as lines 48-62 of the microcontroller provide for communication with components connected to a communication link, such as an S-link, via at least one connecting circuit, such as circuit 63 (Control A-1) or circuits 64-70 (Control-S, illustrated in FIG. 3B). The connecting circuits serve as buffers and drivers to provide suitable interface functions for the communications link serving the second signal protocol.

Operating modes of the microcontroller 42 are selected based on the values of mode select inputs MODA 72 and MODB 74 during reset of the microcontroller 42. To this end, an external reset switch 76 is connected to the microcontroller 42 and to VDD via a 4.7 kohm pull up resistor in the embodiment shown.

The frequency of an internal clock E of the microcontroller 42 is determined by an external oscillator 78, such as a CMOS compatible clock or a crystal, here illustrated as an 8 MHz crystal. The oscillator is suitably connected to XTAL 80 or EXTAL 82 pins of the microcontroller 42, as is known to those skilled in the art. An output connection E 84 of the microcontroller 42 permits use of the internal clock signal of the microcontroller 42 as a timing reference.

Address demultiplexing and look-up are achieved via parallel I/O address data connections 86, read/write function (RW) 88, which controls the direction of transfers on the external data bus, address strobe (AS) 90, which can demultiplex the address and data signals, and NAND gates 92, 94, 96, and 98 provided for address decoding.

Suitable memory devices, such as RAM or ROM memory 102 can be provided and connected to the microcontroller 42 via address data connections 86. Data for a command signal of a component linked to the control device via the interface can be stored in such suitable memory devices. In the exemplary embodiment, the first signal protocol is transmitted to the ROM 102 from the microcontroller 42 via address lines. A corresponding second signal protocol containing the proprietary data for the command signal is retrieved, then transmitted to the microcontroller 42 from the ROM 102 via data lines. The proprietary data of AN components can then be transmitted from the microcontroller 42 to one or more I/O connections, such as Al output link 104, I/O links 48-62, or any other suitable I/O connection. Further, input data from one or more AN components can be transmitted to the microcontroller via suitable I/O lines, such as Al input link 104, and/or bidirectional I/O links 48-62.

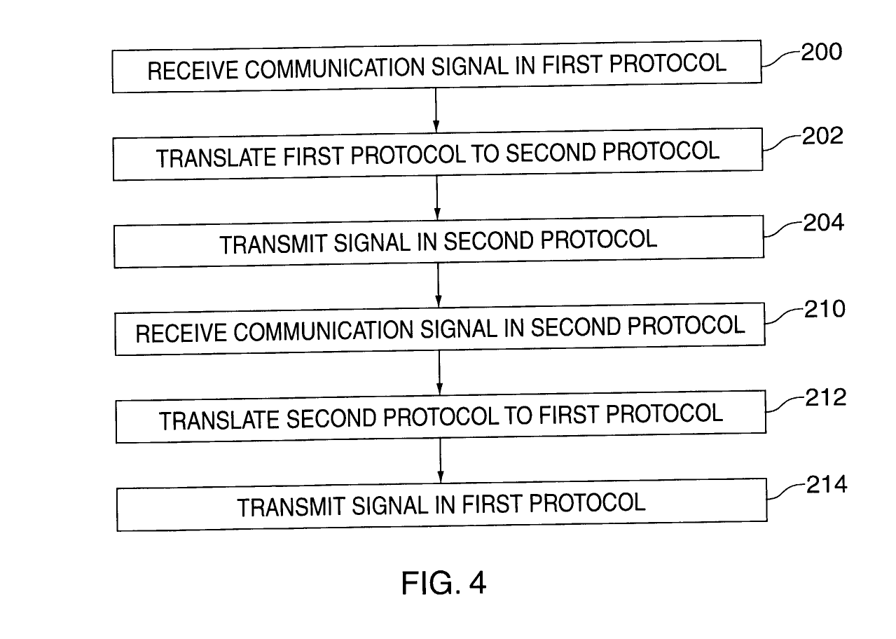

Referring now to FIG. 4, the operation of an embodiment of the present invention is described in flow-chart form. When the control device is activated, a communication signal in the first protocol is received at 200 and translated into the second protocol at 202. The signal is then forwarded to the audio-video electronic component at 204 in the second protocol.

Similarly, when an audio-video component generates a communication signal in the second protocol, it is received at 210, translated to the first protocol at 212 and forwarded to the control device in 214. The detailed description previously provided of the circuit of FIG. 3, provides details of the specific actions required to accomplish the steps described in connection with FIG. 4.

In one embodiment of the invention, touch screen display 14 is used to cotrol the system. Those skilled in the art will appreciate that other display and input devices including RF and infrared devices may be equivalently used.

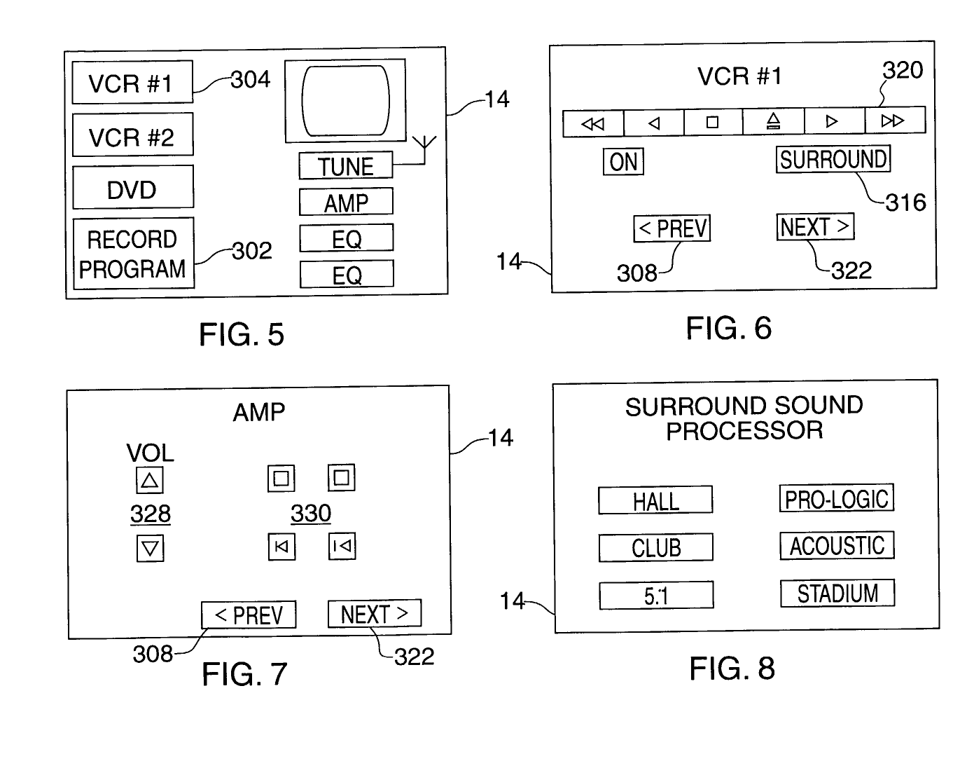

FIG. 5 shows a first screen on the touch screen display 14 for controlling the system's components. By way of example of the operation of the present invention, pressing the record program icon 302 causes an RS 232 command to be issued from control device 12 which is then converted by the look-up table in communication interface 20 to an appropriate control language (such as Control-S or any suitable control language depending upon the manufacturer of the system components). The translated command for the “record” command is then transmitted to the VCR #1, which in this embodiment is the default record device. If the VCR #1 icon 304 is pressed, the control screen for VCR #1 appears as shown in FIG. 6. Note that the system will return to the screen shown in FIG. 5 if the <prev icon 308 is pressed. Icons for all of the components 18 of FIG. 1 are provided on the screen 14 shown in FIG. 5.

The operation of VCR #1 can be controlled using the familiar graphical controls 320 to initiate play actions as if they were front panel controls for a VCR. Pressing the next >icon 322 (or the amplifier icon of FIG. 5) displays the Amplifier screen shown in FIG. 7. The amplifier volume is adjusted using the volume control icons 328. The speakers to be used are selected using the speaker icons 330. If the Surround icon 316 of FIG. 6 is touched, the surround sound processor control screen is displayed as in FIG. 8 permitting the user to select any of a selection of surround sound effects.

As the microcontroller 30 receives each of these commands sent via an RS 232 connection, it translates that command by retrieving an appropriate pulse sequence from memory 32. Each pulse sequence is then transmitted to the proper component 18 via the connection corresponding to the particular component.

The memory 32 preferably stores a representation of pulse sequences for each function of all possible components 18. A manufacturer may program command pulse sequences for each audio-video component it manufactures in the memory 32, thereby allowing users to continually add components to the system. In addition, pulse sequences may be stored in memory 32 that are reserved for use with future products, allowing a manufacturer to offer future products that are backward compatible with the present system. Upgrades can be accomplished by replacement or updating of the memory.

In other embodiments of the invention, information such as the song titles on a compact disc playing in the CD player may be displayed on the touch screen 14. A user may select a song by touching the song name displayed on the screen 14, thereby causing a command to be sent to the microcontroller 30 that in turn sends a pulse sequence stored in memory 32 corresponding to the selection of the desired song number to be transmitted to the CD player.

Similarly, status information about the components 18 is also available to the control device 12 via communication interface 20. Such information can be used to provide a graphic display of the status of the entire system on the touch screen 14. Such status information may include which of the components are currently activated.

While each of the exemplary embodiments described above include a programmed microcontroller in conjunction with various logic circuits and other components, any equivalent integrated circuit (IC) and/or hard wired logic arrangement could be used to accommodate the internal program memory needs of an interface constructed in accordance with the principles of the present invention. Other embodiments could be devised by those skilled in the art. In addition, the value, arrangement, and selection of components shown in FIG. 3 when programmed according to the data and program shown in the microfiche appendix provide an exemplary embodiment of the principles discussed herein, and are not intended to be limiting. Further, the principles of the present invention contemplate providing an open-architecture interface to accommodate the needs of the system, such as, for example, adding one or more additional components or controllers or changing existing components or controllers.

Thus it is apparent that in accordance with the present invention, an apparatus that fully satisfies the objectives, aims, and advantages achievable in accordance with the principles of the present invention is set forth in the above exemplary embodiments. While the invention has been described in conjunction with these exemplary embodiments, it is evident that many alternatives, modifications, permutations, and variations will become apparent to those skilled in the art in light of the foregoing description. Accordingly, it is intended that all such alternatives, modifications, permutations, and variations to the exemplary embodiments can be made without departing from the scope and spirit of the present invention.

What is claimed is:

1. An electronic component system comprising the following:
a control device capable of generating command signals, and receiving communication signals, in accordance with a first signal protocol;
at least one electronic component capable of receiving command signals, and generating communication signals, in accordance with a second signal protocol; and
a communications interface coupled between the control device and the at least one component, the communications interface being adapted and constructed to receive command signals from the control device, translate the command signals from the first signal protocol to the second signal protocol, and transmit the translated command signals to the at least one component.

2. An electronic component system according to claim 1, wherein the communications interface is also adapted and constructed to receive communication signals from the at least one component, translate the communication signals from the second signal protocol to the first signal protocol, and transmit the translated communication signals to the control device.

3. An electronic component system according to claim 1, wherein the first signal protocol comprises an RS 232 command protocol.

4. An electronic component system according to claim 1, wherein the communications interface comprises a microcontroller adapted and constructed to receive and process command signals from the control device.

5. An electronic component system according to claim 1, wherein the communications interface includes a memory device connected to the microcontroller.

6. An electronic component system according to claim 5, wherein the memory device is selected from a group consisting essentially of ROM, RAM, optical storage, and magnetic storage.

7. An electronic component system according to claim 5, wherein said memory device stores a look-up table for translating between said first and second signal protocols.

8. An electronic component system according to claim 1, wherein the communications interface includes an output circuit adapted to transmit data signals from the control device to the at least one component and to transmit status signals from the at least one component to the control device.

9. An electronic component system according to claim 1, wherein the control device comprises an input device and a display device.

10. An electronic component system according to claim 9, wherein the input device comprises an infrared remote control unit.

11. An electronic component system according to claim 9, wherein the input device comprises an infrared remote control unit.

12. An electronic component system according to claim 9, wherein the input device and the display device are integrated into a touch screen.

13. In an electronic component system including a control device capable of communication using a first signal protocol and at least one audio-visual component capable of communication using a second, different signal protocol, a communications interface comprising the following:
command means for transmitting and receiving communication signals from the control device;
translation means, coupled to the command means, for translating signals between the first signal protocol and the second signal protocol; and
input/output means, coupled to the translation means, for transmitting and receiving communication signals from the at least one audio-visual component.

14. An electronic component system according to claim 13, wherein the command means includes an RS 232 switch.

15. An electronic component system according to claim 13, wherein the translation means comprises a microcontroller and a memory device.

16. An electronic component system according to claim 15, wherein said memory includes at look-up table used to translate between said first and second protocols.

17. An electronic component system according to claim 13, wherein said second protocol is selected form the group comprising control-A1, control-S and IEEE 1394.

18. In an electronic component system including a control device capable of communication using a first signal protocol and at least one device capable of communication using a second signal protocol, a method of effecting communication between the control device and the at least one audio-visual component, the method comprising the following steps:
actuating the control device to transmit communication signals;
translating the signals generated from the control device from the first signal protocol to the second signal protocol; and
transmitting the translated communication signals to the at least one audio-visual component.

19. In an electronic component system including a control device capable of communication using a first signal protocol and at least one device capable of communication using a second signal protocol, a method of effecting communication between the at least one audio-visual component and the control device, the method comprising the following steps:
actuating the at least one audio-visual component to transmit communication signals;
translating the signals generated from the at least one audio-visual component from the second signal protocol to the first signal protocol; and
transmitting the translated communication signals to the control device.

20. In an electronic component system including a control device capable of communication using a first signal protocol and at least one audio-visual component capable of communication using a second, different signal protocol, a communications interface comprising the following:
a microcontroller adapted and constructed to recognize, and to transmit and receive, communication signals from the control device;
at least one input/output connection adapted and constructed for connection between the communications interface and the at least one audio-visual component, the input/output connection being capable of transmitting data to, and receiving status signals from, the at least one audio-visual component; and
a memory device connected between the microcontroller and the at least one input/output connection, the memory device being adapted and constructed to receive first-protocol signals from the microcontroller, translate the first-protocol signals into second-protocol signals, and transmit the translated signals to the at least one input/output connection, and
receive second-protocol signals from the at least one input/output connection, translate the second-protocol signals into first-protocol signals, and transmit the translated signals to the microcontroller.

21. An electronic component system according to claim 20, wherein the first signal protocol comprises an RS 232 command protocol.

22. An electronic component system according to claim 20, wherein the second signal protocol comprises binary status signals.

23. An electronic component system according to claim 20, wherein the memory device comprises a ROM.

24. An electronic component system according to claim 20, wherein the memory device comprises a RAM.
